(19) United States
(12) Patent Application Publication
(10) Pub. No.: US 2013/0255508 A1
(43) Pub. Date: Oct. 3, 2013

(54) Convective Cooking Apparatus

(71) Applicant: Convectop, LLC, Dublin, CA (US)

(72) Inventors: Dean Finnegan, Dublin, CA (US); Zeb Stewart, San Francisco, CA (US); Michael T. Northen, San Francisco, CA (US); Dallas A. Swindle, IV, San Francisco, CA (US)

(73) Assignee: Convectop, LLC, Dublin, CA (US)

(21) Appl. No.: 13/902,417

(22) Filed: May 24, 2013

Related U.S. Application Data
(63) Continuation-in-part of application No. 13/553,361, filed on Jul. 19, 2012.
(60) Provisional application No. 61/509,820, filed on Jul. 20, 2011.

(51) Int. Cl. A47J 27/00

(52) U.S. Cl. CPC A47J 27/002
USPC 99/341; 99/447

(57) ABSTRACT

A convective cooking apparatus is provided. In some embodiments, the convective cooking apparatus includes a lid that provides for a more effective cooking environment through improved heat capture and/or by creating a convective cooker. Waste heat that normally escapes up the side of a pan is captured by an overhang of the lid and redirected back into the pan and onto the food. In some embodiments, the convective cooking lid includes topographical changes on the surface of the lid adjacent to the pan, the topographical changes inducing a turbulent air flow between the pan and the conductive lid.

### CROSS REFERENCE TO RELATED INFORMATION

This application is a continuation-in-part application of application No. 13/553,361, filed Jul. 19, 2012, which claims the benefit of U.S. Provisional Patent Application No. 61/509,820, filed Jul. 20, 2011, the contents of which are hereby incorporated herein in its entirety.

### TECHNICAL FIELD

The present disclosure is directed to cooking implements, and more particularly to pots and pans that include lids designed to capture and redirect heat within the pot or pan.

### BACKGROUND OF THE INVENTION

Various forms of cooking apparatus exist. Example cooking apparatus include various forms of pots and pans that can be placed on cooking ranges or stove tops (e.g., gas or electric stove tops). Some such cooking apparatus can include lids to maintain heat, such as a lid that can be placed on top of a pot or pan, such as for boiling a pot of water.

### BRIEF SUMMARY OF THE INVENTION

In a preferred embodiment an apparatus for cooking is described. The apparatus includes a pan, and a convective lid having a diameter of a base that exceeds a diameter of a base of the pan. The convective lid including topographical changes on the surface of the lid adjacent to the pan to induce a turbulent air flow between the pan and the conductive lid.

A lid for use with a pan for cooking, the lid including a base having a diameter larger than diameter of the pan such that the lid overhangs the edge of the pan to allow waste heat to enter the lid from around the sides of the pan. The lid further includes a venturi vent in the top of the pan, and topographical changes on an under surface of the lid adjacent to the pan, the topographical changes inducing a turbulent air flow between the pan and the conductive lid.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates a side-view of a convective cooking apparatus in accordance with some embodiments.

FIG. 2 illustrates another side-view of a convective cooking apparatus in accordance with some embodiments.

FIG. 3A-3B illustrate a convective cooking apparatus as viewed from above in FIG. 3A and as view from below in FIG. 3B in accordance with some embodiments.

FIG. 4 illustrates a convective cooking apparatus as viewed from above in accordance with some embodiments.

FIG. 5A-5B illustrate a side-view of a convective cooking apparatus as it is being lowered over a pan in FIG. 5A and resting over the pan in FIG. 5B in accordance with some embodiments.

FIG. 6 illustrates a side-view of a convective cooking apparatus in accordance with some embodiments.

FIG. 7 illustrates a side-view of a convective cooking apparatus in accordance with some embodiments.

FIGS. 8A-8F illustrate various shapes of a convective cooking apparatus from a side-view perspective in accordance with some embodiments.

FIG. 9 illustrates a side-view of a convective cooking apparatus in accordance with some embodiments.

FIG. 10 illustrates a side-view of a convective cooking apparatus in accordance with some embodiments.

FIGS. 11A-11B illustrate two different side-views of a convective cooking apparatus in accordance with some embodiments.

FIG. 12 illustrates a side-view of a convective cooking apparatus as viewed from above in accordance with some embodiments.

FIG. 13 illustrates a side-view of a convective cooking apparatus with a fuel source in accordance with some embodiments.

FIG. 14 illustrates another side-view of a convective cooking apparatus with a fuel source in accordance with some embodiments.

FIG. 15 illustrates another side-view of a convective cooking apparatus with a fuel source in accordance with some embodiments.

FIGS. 16A-16C illustrate side-views of a convective cooking apparatus in accordance with some embodiments.

FIGS. 17A-17C illustrate side-views of a convective cooking apparatus in accordance with some embodiments.

FIG. 18 illustrates a side-view of a convective cooking apparatus in accordance with some embodiments.

FIG. 19 illustrates a top-view and a side-view of a convective cooking apparatus in accordance with some embodiments.

FIG. 20 illustrates a top-view and a side-view of a convective cooking apparatus in accordance with some embodiments.

FIG. 21 illustrates a top-view and a side-view of a convective cooking apparatus in accordance with some embodiments.

FIG. 22 illustrates a top-view and a side-view of a convective cooking apparatus in accordance with some embodiments.

FIGS. 23A-23C illustrate side-views of a convective cooking apparatus in accordance with some embodiments.

FIG. 24 illustrates a side-view of a convective cooking apparatus in accordance with some embodiments.

FIG. 25 illustrates a top-view and a side-view of a convective cooking apparatus in accordance with some embodiments.

FIG. 26A-26B illustrates side-views of a convective cooking apparatus in accordance with some embodiments.

FIG. 27 illustrates a side-view of a convective cooking apparatus in accordance with some embodiments.

FIG. 28 illustrates a side-view of a convective cooking apparatus in accordance with some embodiments.

FIG. 29 illustrates a top view of an alternate embodiment of a convective cooking apparatus and lid according to the concepts described herein.

FIG. 30 illustrates a sectional side view of the convective cooking apparatus and lid shown in FIG. 29 along line A-A

FIG. 31 illustrates a sectional detail side view of portion D of the convective cooking apparatus and lid shown in FIG. 30.

FIG. 32 illustrates a sectional detail side view of portion B of the convective cooking apparatus and lid shown in FIG. 30.

FIG. 33 illustrates a sectional detail side view of portion C of the convective cooking apparatus and lid shown in FIG. 30.

FIG. 34 illustrates a bottom view of the convective cooking apparatus and lid shown in FIG. 24.

FIG. 35 illustrates a bottom perspective view of the convective cooking apparatus and lid shown in FIG. 24.

FIG. 36 illustrates a side view of the convective cooking apparatus and lid shown in FIG. 24.

FIG. 37 illustrates a sectional side view of the convective cooking apparatus and lid shown in FIG. 34 along line A-A.

FIGS. 38a and 38b illustrate a top perspective view and a side perspective view of a section of convective cooking apparatus and lid shown in FIG. 29.

FIGS. 39a and 39b illustrate side sectional views of a section of convective cooking apparatus and lid shown in FIG. 29.

FIG. 40 illustrates a side perspective view of an embodiment of a convective cooking apparatus and lid according to the concepts described herein.

### DETAILED DESCRIPTION OF THE INVENTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various forms of cooking apparatus exist. Example cooking apparatus include various forms of pots and pans that can be placed on cooking ranges or stove tops (e.g., gas or electric stove tops). Some such cooking apparatus can include lids to maintain heat, such as a lid that can be placed on top of a pot or pan, such as for boiling a pot of water. The use of a lid can increase the heat maintained inside the pot or pan while the pot or pan is on an active cooking range or stove top.

However, significant amounts of heat are still loss while using a pot or pan on an active cooking range or stove top. For example, heat loss occurs through heat convecting up the sides of the pot or pan (e.g., which is lost as it is transferred into the surrounding air of the room).

Accordingly, a convective cooking apparatus is provided. In some embodiments, a convective cooking apparatus captures and/or redirects much of the heat that can be traveling up the side of the pot or pan or other cooking apparatus back into the local cooking environment. For example, a convective cooking apparatus facilitates directing the heat into the pot, pan, griddle, grill, and/or other cooking apparatus. As a result, the heat is redirected and captured within the cooking environment.

In some embodiments, the heat can also be regulated through the use (e.g., opening and closing) of a vent provided with the convective cooking apparatus. For example, with the vent open, the convective cooking apparatus provides a convective cooking environment with hot air moving through the cooking environment. In some embodiments, the amount the vent can be opened is variable (e.g., a variable mechanism or variable setting).

In some embodiments, the convective cooking apparatus includes a lid that provides for a more effective cooking environment through improved heat capture and/or by creating a convective cooker.

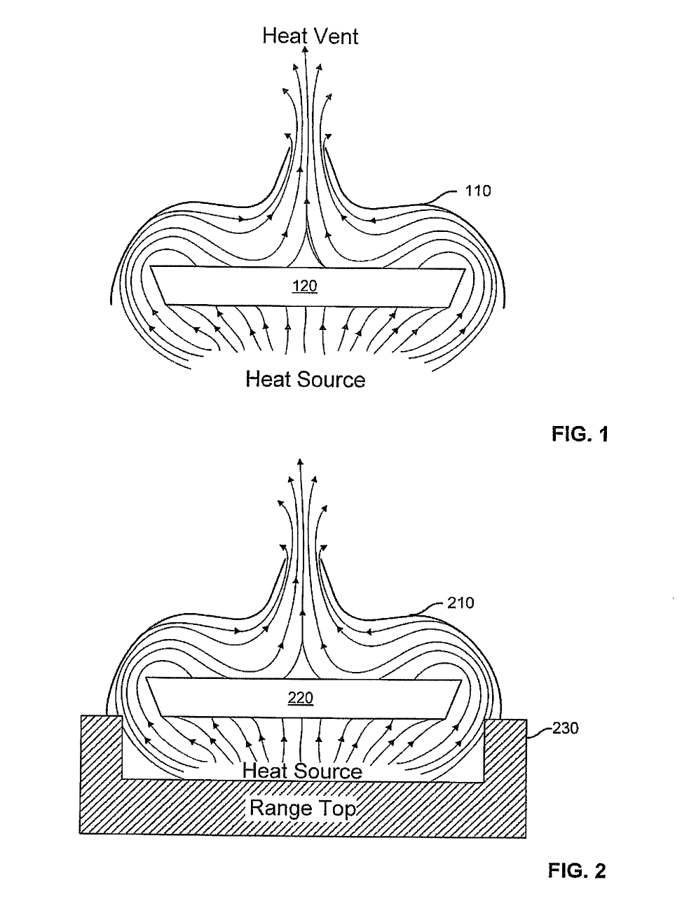

FIG. 1 illustrates a side-view of a convective cooking apparatus in accordance with some embodiments. As shown, the convective cooking apparatus 110 redirects heat from the side of the pan over the top of the pan 120. The heat is then channeled out the top of the convective cooking apparatus. In some embodiments, the cooking apparatus 110 includes one or more of the following materials: aluminum, cast iron, glass, high temperature silicone, steel, and ceramic.

FIG. 2 illustrates another side-view of a convective cooking apparatus in accordance with some embodiments. As shown, the convective cooking apparatus includes a convective lid 210 sitting on top of a range top or stove top 230. The convective lid captures heat from the sides of the pan and redirects it over the top of the pan 220.

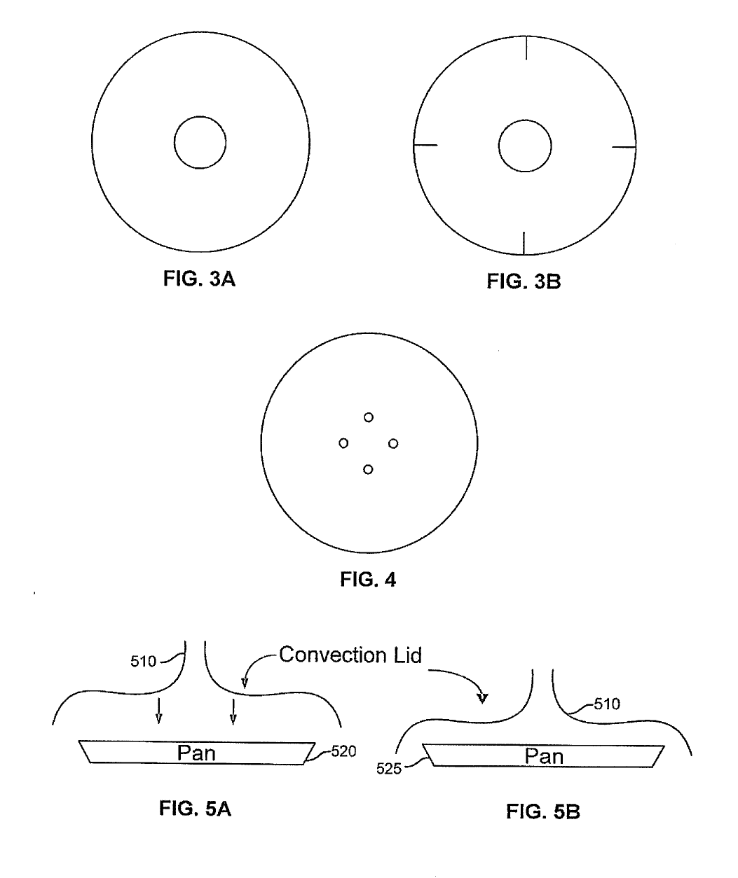

FIGS. 3A-3B illustrate a convective cooking apparatus as viewed from above in FIG. 3A and as view from below in FIG. 3B in accordance with some embodiments. As shown, the convective cooking apparatus includes a vent hole that is visible, and the struts supporting the convective lid on the top of a cooking apparatus, such as a pot or pan. As shown, four struts are provided. In some embodiments, a fewer or greater number of struts can be provided.

FIG. 4 illustrates a convective cooking apparatus as viewed from above in accordance with some embodiments. As shown, the convective cooking apparatus includes multiple holes that are used as vents. As shown, four holes are provided. In some embodiments, a fewer or greater number of holes can be provided.

FIGS. 5A-5B illustrate a side-view of a convective cooking apparatus 510 as it is being lowered over a pan 520 in FIG. 5A and resting over the pan 525 in FIG. 5B in accordance with some embodiments.

FIG. 6 illustrates a side-view of a convective cooking apparatus in accordance with some embodiments. As shown, the convective cooking apparatus 610 includes a variable opening 615 at the top of the convective cooking apparatus, which is adapted to rest on a pan 620. The variable opening can facilitate control over the flow of heat.

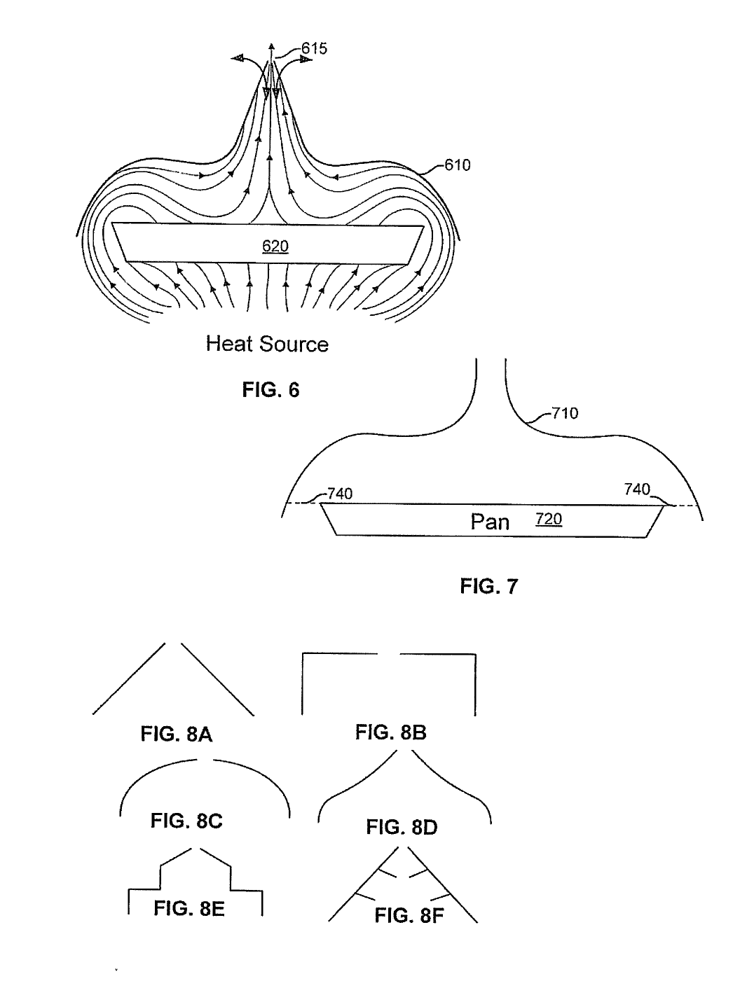

FIG. 7 illustrates a side-view of a convective cooking apparatus in accordance with some embodiments. As shown, the convective cooking apparatus 710 is resting on top of the pan 720 with supports 740 radially spaced around the periphery of the convective lid.

FIGS. 8A-8F illustrate various shapes of a convective cooking apparatus from a side-view perspective in accordance with some embodiments. As shown, the convective cooking apparatus can be formed into a variety of different shapes. Various other shapes can be used in to provide for the convective cooking apparatus as will now be apparent to one of ordinary skill in view of the various embodiments described herein.

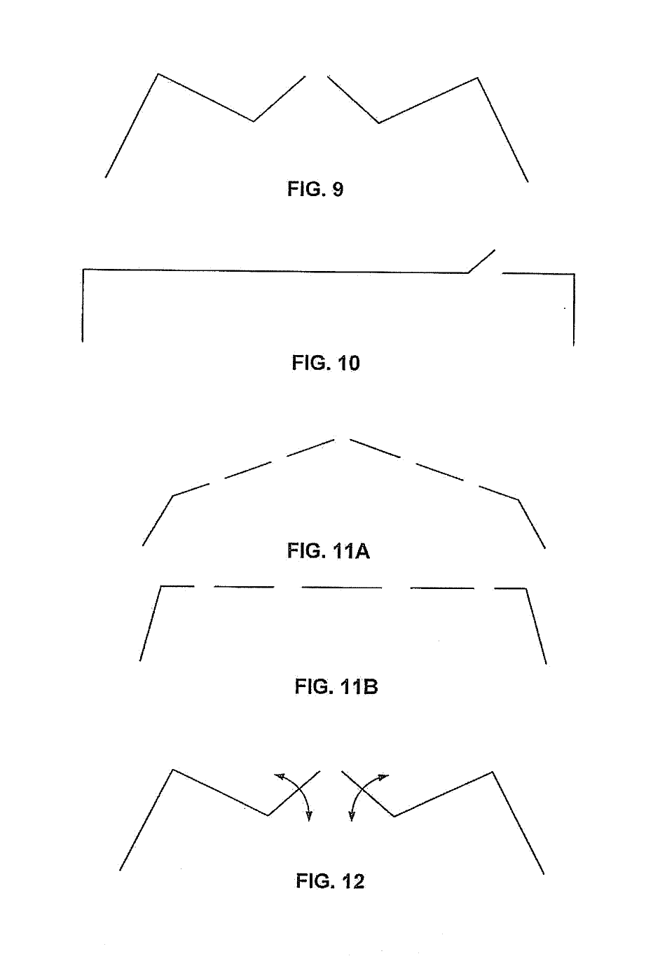

FIG. 9 illustrates a side-view of a convective cooking apparatus in accordance with some embodiments. As shown, the convective cooking apparatus includes multiple angles to control heat flow characteristics.

FIG. 10 illustrates a side-view of a convective cooking apparatus in accordance with some embodiments. As shown, the convective cooking apparatus includes an opening at the top of the convective lid, which is not located in the center. In some embodiments, the opening is located at various other locations of the top of the convective lid.

FIGS. 11A-11B illustrate two different side-views of a convective cooking apparatus in accordance with some embodiments. As shown, the convective cooking apparatus includes several holes in the top.

FIG. 12 illustrates a side-view of a convective cooking apparatus as viewed from above in accordance with some embodiments. As shown, the convective cooking apparatus includes flaps that can be opened variably (e.g., using a variable opening mechanism or a variable setting).

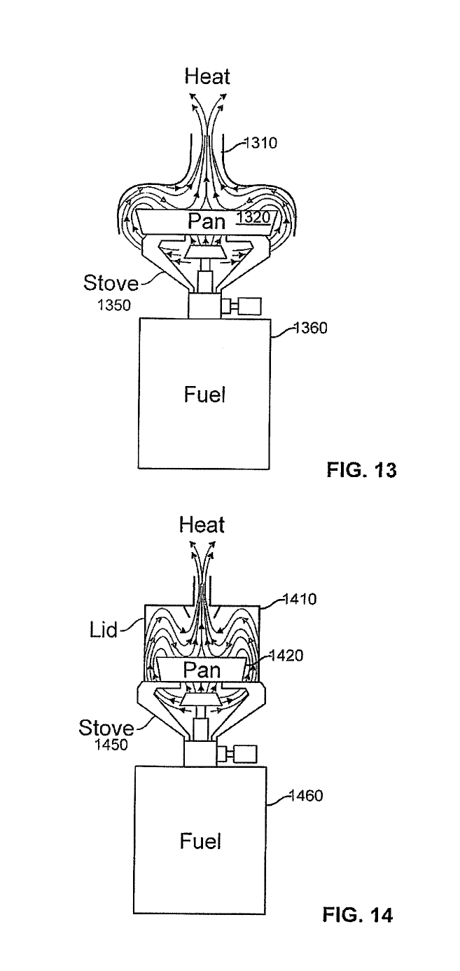

FIG. 13 illustrates a side-view of a convective cooking apparatus with a fuel source in accordance with some embodiments. As shown, the convective cooking apparatus includes a convective lid 1310 that is used in conjunction with a camp stove 1350, on which rests a pan 1320, and the cooking apparatus is connected to a fuel source 1360 (e.g., using propane fuel tank or another portable fuel source and mechanism), in which the convective lid 1310 rests on the camp stove surface as shown. For example, the convective lid can improve the efficiency of the camp stove.

FIG. 14 illustrates another side-view of a convective cooking apparatus with a fuel source in accordance with some embodiments. As shown, the convective cooking apparatus includes a convective lid 1410 that is used in conjunction with a camp stove 1450, on which rests a pan 1420, and the cooking apparatus is connected to a fuel source 1460 (e.g., using propane fuel tank or another portable fuel source and mechanism), in which the convective lid rests on the camp stove surface as shown. Heat from the sides of the pan is focused to the interior of the pan. For example, the convective lid can be provided using various other shapes for this example use scenario and application.

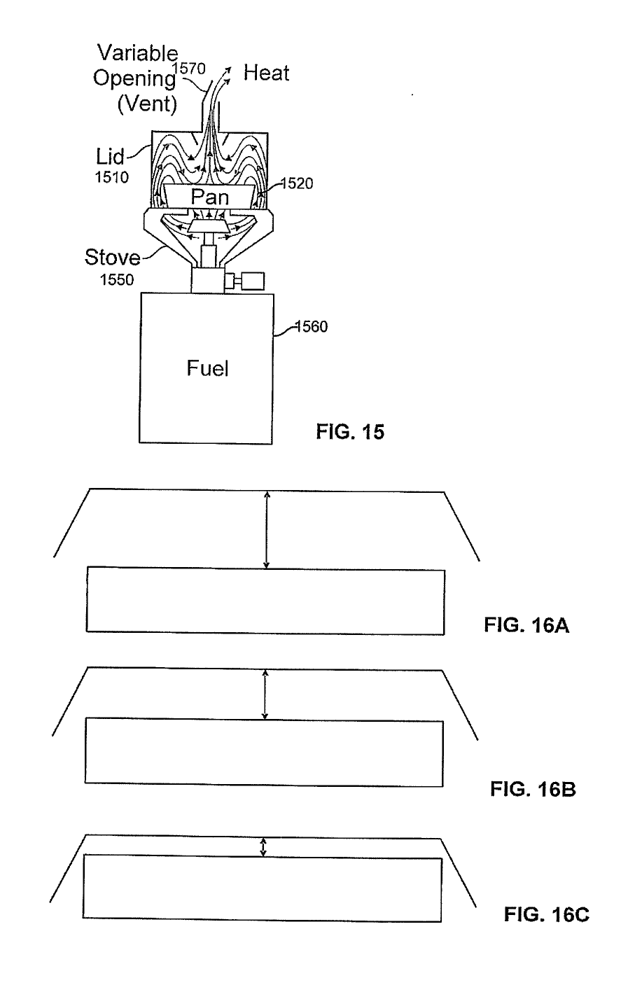

FIG. 15 illustrates another side-view of a convective cooking apparatus with a fuel source in accordance with some embodiments. As shown, the convective cooking apparatus includes a variable opening 1570 (e.g., a vent). In this example, the vent 1570 is located on the top of the convective lid 1510, which rests over a pan 1520 on top of the cooking surface of the camp stove 1550, which includes a fuel source 1560 as shown. In some embodiments, the vent is located in another location on the lid surface. For example, the vent can allow a user to variably control the cooking environment.

FIGS. 16A-16C illustrate side-views of a convective cooking apparatus in accordance with some embodiments. As shown, the convective cooking apparatus includes a convective lid that has variable height control.

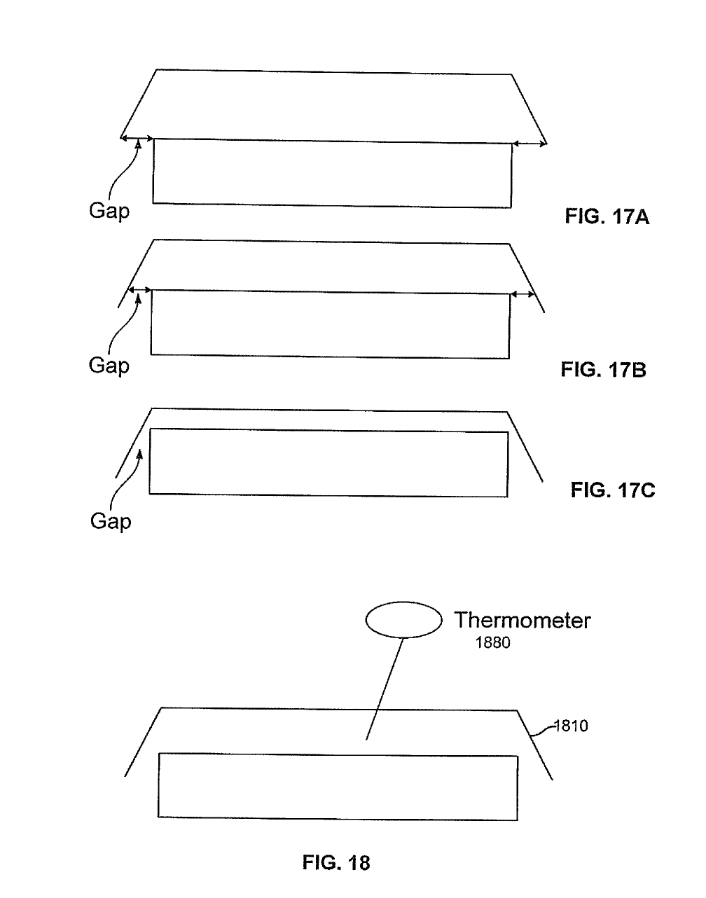

FIGS. 17A-17C illustrate side-views of a convective cooking apparatus in accordance with some embodiments. As shown, the convective cooking apparatus includes a convective lid that has a variable gap control between the edge of the pan and the convective lid.

FIG. 18 illustrates a side-view of a convective cooking apparatus in accordance with some embodiments. As shown, the convective cooking apparatus includes a convective lid 1810 that has a built-in thermometer 1880 (e.g., or attachable thermometer component) to monitor an internal temperature.

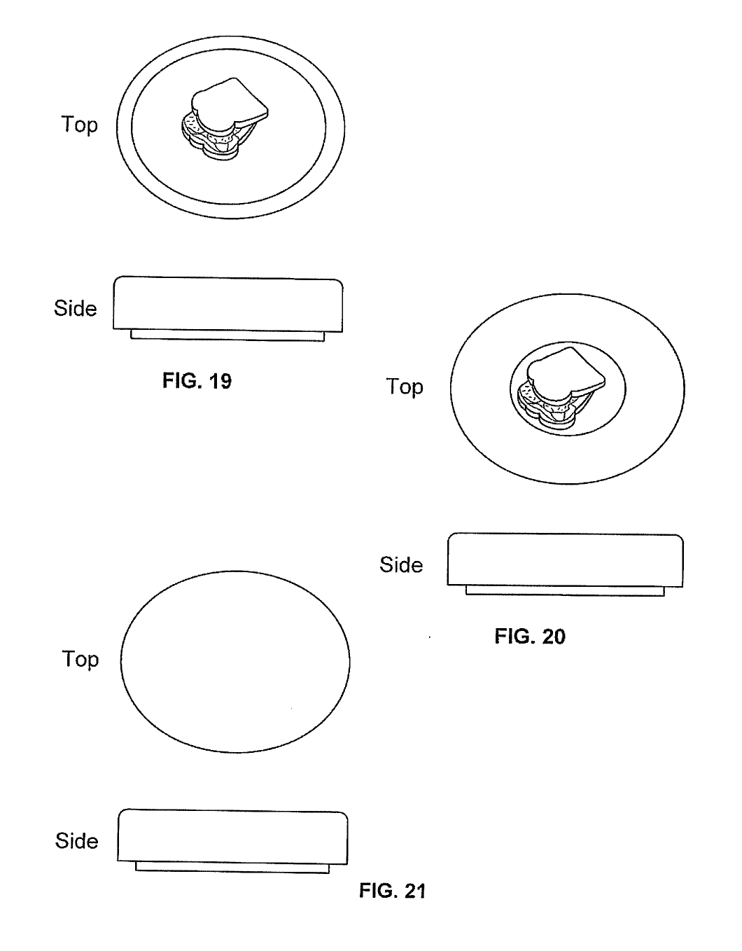

FIG. 19 illustrates a top-view and a side-view of a convective cooking apparatus in accordance with some embodiments. As shown, the convective cooking apparatus includes a convective lid that is transparent.

FIG. 20 illustrates a top-view and a side-view of a convective cooking apparatus in accordance with some embodiments. As shown from the top-view perspective, the convective cooking apparatus includes a viewing window in a top portion of the convective cooking apparatus. In some embodiments, the viewing window can be located in various other locations of the convective cooking apparatus.

FIG. 21 illustrates a top-view and a side-view of a convective cooking apparatus in accordance with some embodiments. As shown, the convective cooking apparatus includes a convective lid and a cooking pan (e.g., or cooking pot).

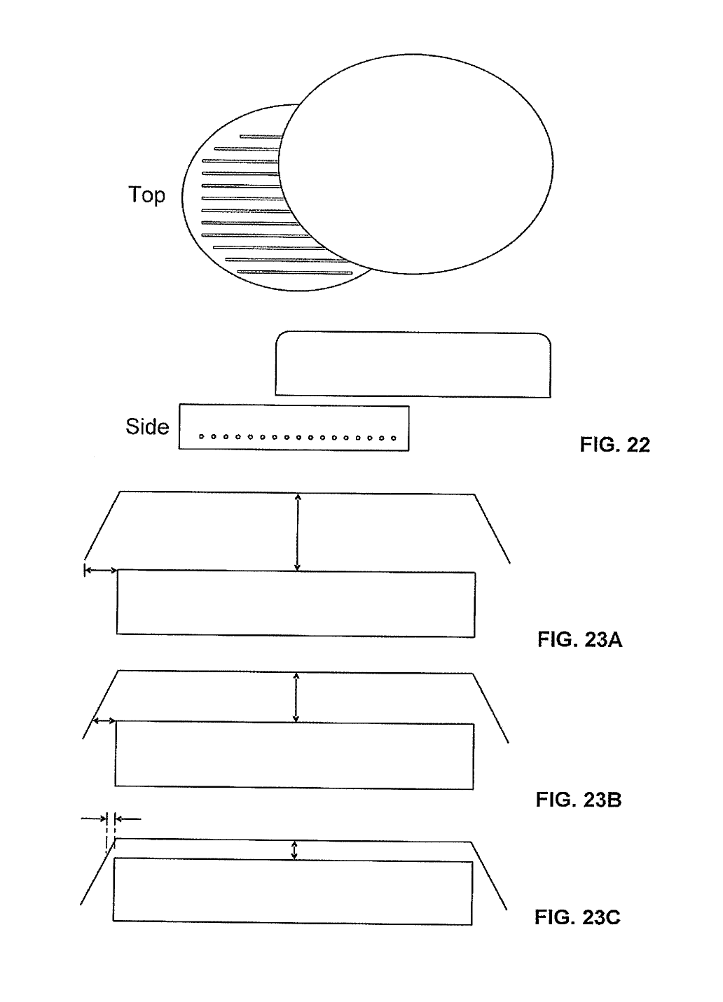

FIG. 22 illustrates a top-view and a side-view of a convective cooking apparatus in accordance with some embodiments. As shown, the convective cooking apparatus includes a convective lid and a cooking pan with a grill.

FIGS. 23A-23C illustrate side-views of a convective cooking apparatus in accordance with some embodiments. As shown, the convective cooking apparatus includes a convective lid and a cooking pan with the mechanism or setting to control the height and a gap between the convective lid and the cooking pan.

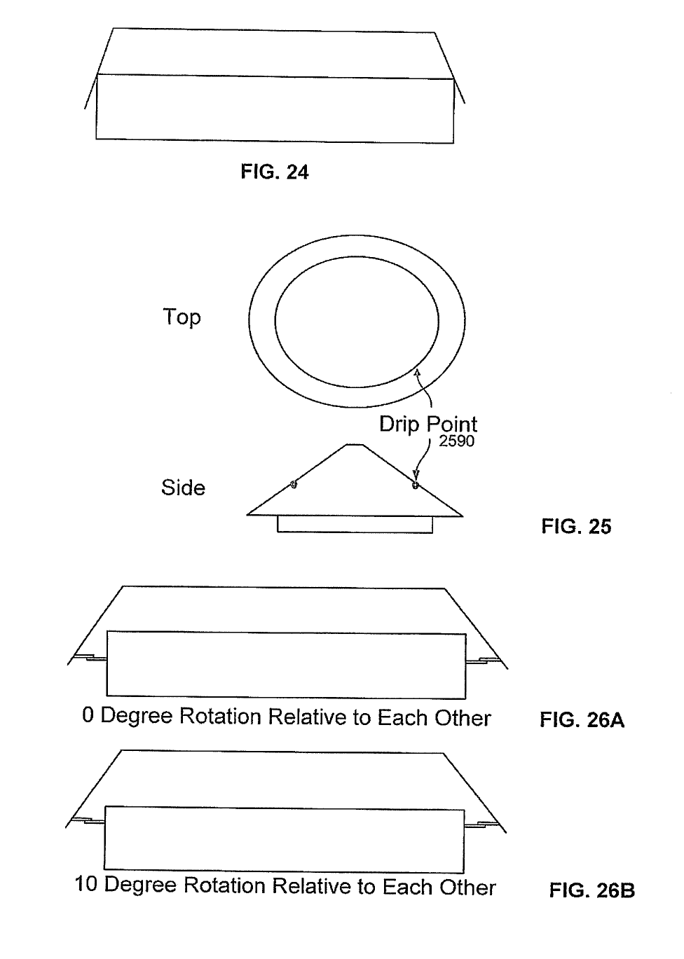

FIG. 24 illustrates a side-view of a convective cooking apparatus in accordance with some embodiments. As shown from the top-view perspective, the convective cooking apparatus includes a convective lid and a pan that can be sealed to create a closed cooking environment (e.g., which can be effective for steaming and/or other applications).

FIG. 25 illustrates a top-view and a side-view of a convective cooking apparatus in accordance with some embodiments. As shown, the convective cooking apparatus includes a convective lid with drip points 2590 that redirect condensed liquid back into the pan.

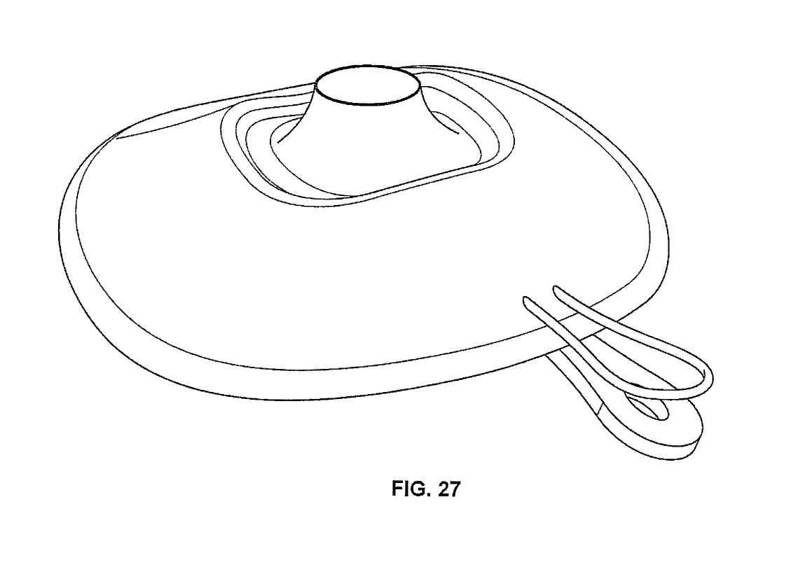

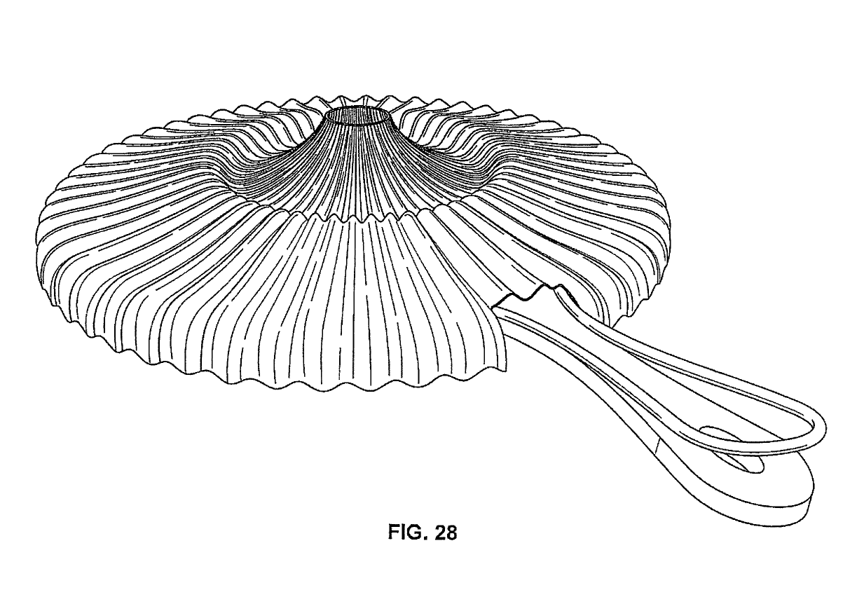

FIG. 26A-26B illustrates side-views of a convective cooking apparatus in accordance with some embodiments. As shown, the convective cooking apparatus includes a convective lid and a pan that include complimentary mating points, which facilitate variable height control, shown as providing a 0 degree rotation relative to each other in FIG. 26A and shown as providing a 10 degree rotation relative to each other in FIG. 26B.

FIG. 27 illustrates a side-view of a convective cooking apparatus in accordance with some embodiments. In some embodiments the convective cooking apparatus includes a plurality of lobes for holding the convective lid on the pan to provide for a plurality of ventilation paths into the pan.

FIG. 28 illustrates a side-view of a convective cooking apparatus in accordance with some embodiments. In some embodiments, the convective lid includes a corrugated shape as shown. In some embodiments, the convective lid includes a corrugated shape, and the corrugations in the convective lid provide for a plurality of ventilation paths into the pan.

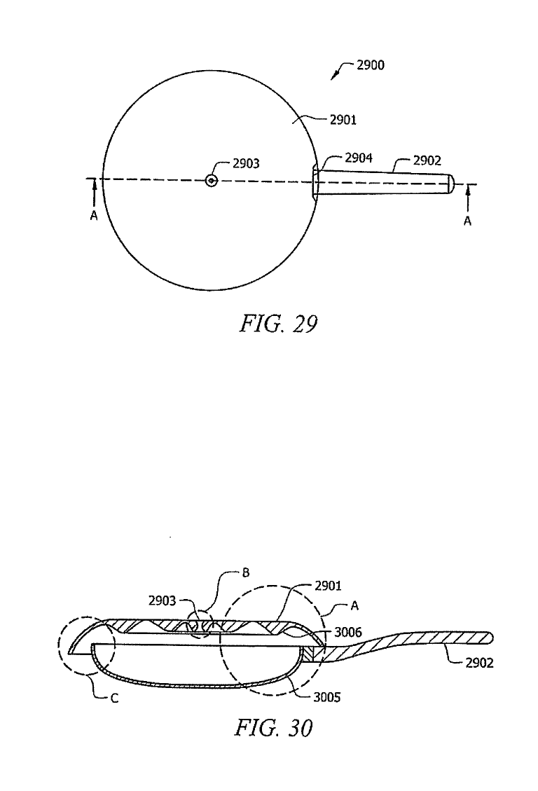

FIGS. 29 and 30 illustrate an alternate embodiment of a convective cooking apparatus and lid in accordance with the concepts described herein. Convective cooking apparatus 2900 includes lid 2901 which includes additional features to promote turbulent flow of air within convective cooking apparatus 2900. As described above, lid 2901 fits over pan 3005 with an overhang, of preferably 1-2 inches, to allow the waste heat from around pan 3005 to be captured and directed into cooking apparatus 2900 and down onto the food in the pan. An indent 2904 in lid 2901 accommodates handle 2902 attached to pan 3005. Venturi nozzle 2903 in lid 2901 acts to choke the flow of air and accelerate the airflow leaving the top of lid 2901. Topographical changes, such as ridge 3006 on the interior of lid 2901 help create a turbulent flow of air within cooking apparatus 2900. The turbulent flow improves heat circulation within cooking apparatus 2900, thereby allowing food to cook from all directions through convection.

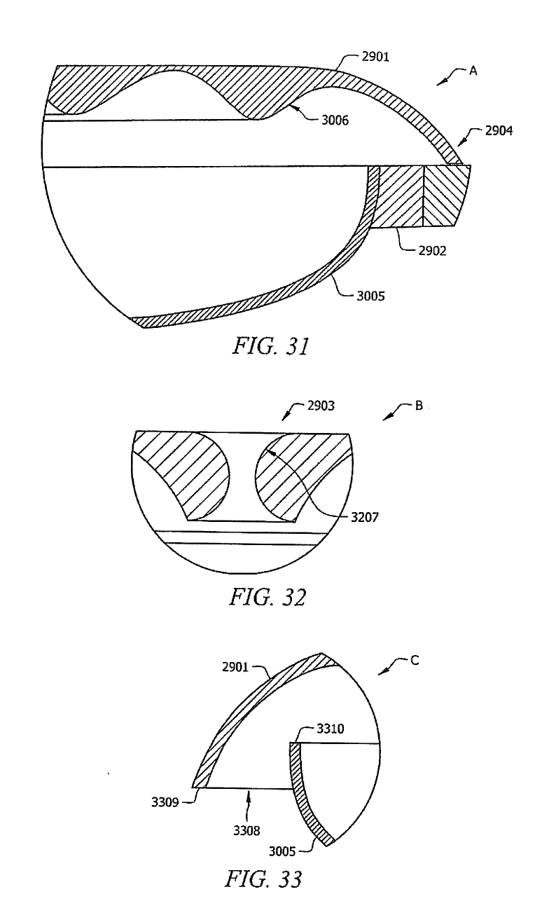

FIGS. 31 through 33 illustrate detail views of various aspects of cooking apparatus 2900 and lid 2901 from FIGS. 29 and 30. FIG. 31 shows the topographical change in the inner surface of lid 2901 caused by ridge 3006. Indent 2904 allows for lid 2901 to fit over handle 2902 of pan 3005. FIG. 32 shows venture nozzle 2903 in greater detail. FIG. 33 shows the overhang 3308 of lid 2901 where the edge 3309 of lid 2901 extends beyond and below the edge 3310 of pan 3005 allowing lid 2901 to capture waste heat rising around the sides of pan 3005, as stated above, this waste heat that would normally escape into air outside the cooking apparatus is captured by lid 2901 and redirected into pan 3005 and down onto the food being cooked.

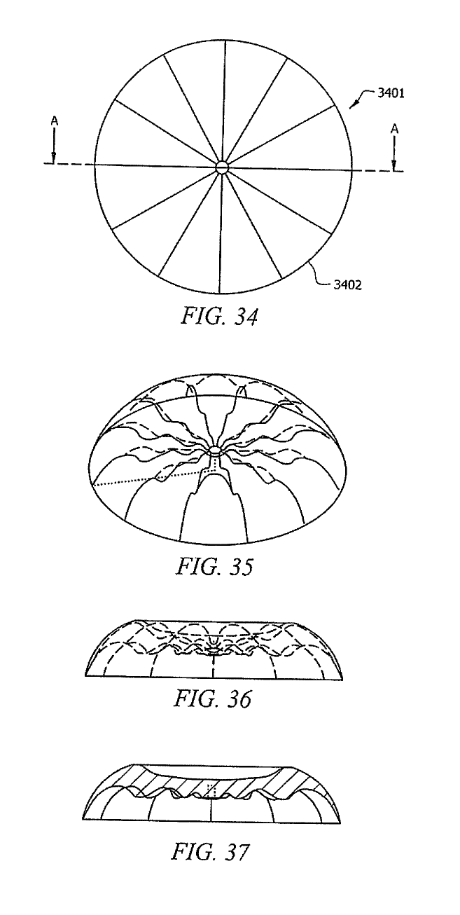

FIGS. 34 through 37 show an embodiment of a lid having according to the concepts described herein, configured to promote turbulent flow through topographical changes in the underside of the lid. Lid 3401 is formed by repeating sections or wedges 3402 that combine to promote turbulent airflow and convective cooking under lid 3401.

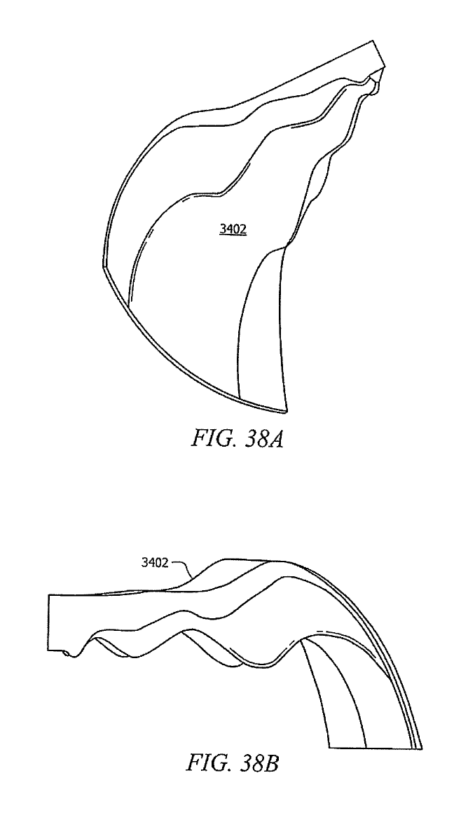

FIGS. 38a and 38b illustrate the shape of an individual section 3402 from the lid shown in FIGS. 34-37.

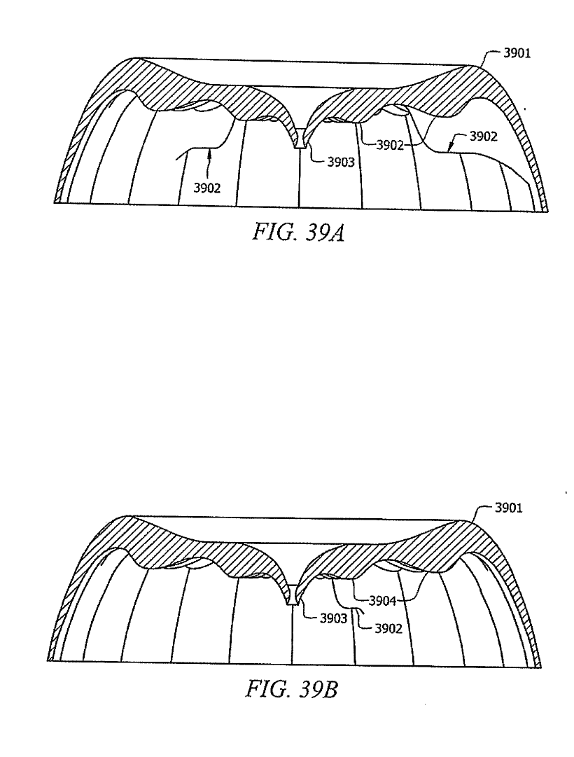

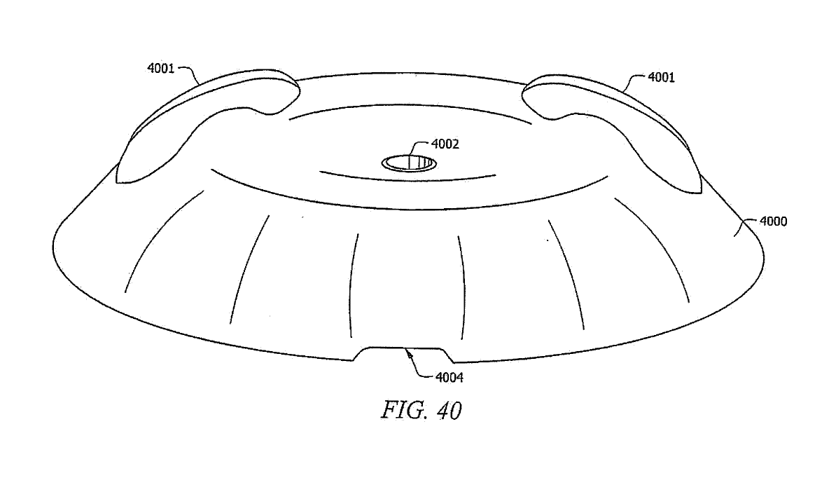

FIGS. 39a and 39b illustrate an alternate embodiment of a lid 3901 designed to promote turbulent air flow and convective cooking. Lid 3901 includes the topographical changes described above, but in addition the central venture channel 3903 is lower, relative to the pan, than the turbulence rings 3904, thereby directing heat and airflow onto the food below. Standoffs 3902 allow lid 3901 to rest on the edge of a pan allowing for the overhang described above to capture rising heat from around the sides of the pan that would normally be wasted.

FIG. 40 illustrates embodiments of additional features that can be incorporated into a lid 4000 according to the concepts described herein. Indent 4004 allow for the handle of a pan to pass under lid 4000 without disrupting the desired overhang of the lid. Handles 4001 allow a user to manipulate the lid 4000 while keeping the user's hands away from heating escaping from the central venture channel 4002.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus for cooking, comprising:
a pan; and
a convective lid, wherein a diameter of a base of the convective lid exceeds a diameter of a base of the pan such that the lid overhangs the edge of the pan to allow heat to enter the lid, and wherein the convective lid includes topographical changes on the surface of the lid adjacent to the pan, the topographical changes inducing a turbulent air flow between the pan and the conductive lid.

2. The apparatus recited in claim 1, wherein the convective lid includes a vent.

3. The apparatus recited in claim 1, wherein the topographical changes are in the form of turbulence rings formed in the surface of the lid adjacent to the pan.

4. The apparatus recited in claim 1, wherein the convective lid includes one or more standoffs to support the lid above the pan.

5. The apparatus recited in claim 2, wherein an opening in the vent is lower than the topographical changes on the surface of the lid to direct heat onto a cooking surface of the pan.

6. The apparatus recited in claim 1, wherein the convective lid includes a control for variably raising and lowering a height of the convective lid from the pan.

7. The apparatus recited in claim 1, wherein the convective lid includes a plurality of supports radially spaced around a periphery of the convective lid.

8. The apparatus recited in claim 1, wherein at least a portion of the convective lid is transparent.

9. A lid for use with a pan for cooking, the lid comprising:
a base having a diameter larger than diameter of the pan such that the lid overhangs the edge of the pan to allow heat to enter the lid from around the sides of the pan;
a venturi vent in the top of the pan; and
topographical changes on an under surface of the lid adjacent to the pan, the topographical changes inducing a turbulent air flow between the pan and the conductive lid.

10. The apparatus recited in claim 9, wherein the vent is adjustable.

11. The apparatus recited in claim 9, wherein the topographical changes are in the form of turbulence rings formed in the surface of the lid adjacent to the pan.

12. The apparatus recited in claim 9, wherein the convective lid includes one or more standoffs to support the lid above the pan.

13. The apparatus recited in claim 10, wherein an opening in the vent is lower than the topographical changes on the surface of the lid to direct heat onto a cooking surface of the pan.

14. The apparatus recited in claim 9, wherein the convective lid includes a control for variably raising and lowering a height of the convective lid from the pan.

15. The apparatus recited in claim 9, wherein the convective lid includes a plurality of supports radially spaced around a periphery of the convective lid.
